(19) United States
(12) Patent Application Publication
(10) Pub. No.: US 2024/0409784 A1
(43) Pub. Date: Dec. 12, 2024

(54) COOLING PLATE ASSEMBLY, METHOD OF MAKING THE SAME, AND CURABLE COMPOSITION

(71) Applicant: 3M INNOVATIVE PROPERTIES COMPANY, St. Paul, MN (US)

(72) Inventors: Lianzhou Chen, Woodbury, MN (US); Surender Maddela, Woodbury, MN (US); Tobias Pick, Korschenbroich (DE); Jason V. Ames, Oakdale, MN (US)

(21) Appl. No.: 18/697,567

(22) PCT Filed: Sep. 7, 2022
(86) PCT No.: PCT/IB2022/058429

§ 371 Date: Apr. 1, 2024

Related U.S. Application Data
(60) Provisional application No. 63/252,215, filed on Oct. 5, 2021.

(51) Int. Cl. C09J 7/38; C09J 5/00; C09J 11/04; C09J 11/08; H01M 10/613; H01M 10/6554; H01M 10/6567

(52) U.S. Cl. CPC C09J 7/38; C09J 5/00; C09J 11/04; C09J 11/08; H01M 10/613; H01M 10/6554; H01M 10/6567; C09J 2203/33; C09J 2301/204

(57) ABSTRACT

A cooling plate assembly comprises at least two component plates bonded together by an adhesive. The adhesive and the at least two component plates collectively define at least one fluid conduit having an inlet and an outlet. The adhesive comprises an epoxy-functional hydrolyzable organosilane compound. A method of making the cooling plate assembly, and a curable composition useful for making the adhesive are also disclosed.

### BACKGROUND

Batteries are used as power sources for electric vehicles. During the operation or charging of a vehicle battery, the battery heats up. As a result of the heating, the vehicle battery can age prematurely or be damaged due to heat-promoted chemical reactions. It is therefore common practice to provide cooling in order to keep the vehicle battery at an optimal operating temperature. Cooling plate assemblies (or simply cooling plates) through which fluid can flow have proven to be a suitable means for cooling items such as, for example, a vehicle battery.

Usually, individual components of cooling plate assemblies are joined together by, for example, welding, soldering, or brazing. At least one cooling channel having an inlet and an outlet is usually contained between the individual components of the cooling plate assemblies. Often, portions of fluid conduits are molded into the individual components of the cooling plate by mechanical shaping processes such that when they are assembled with the other components a fluid conduit is formed by joining the components.

### SUMMARY

Adhesive bonding may be better suited and/or more environmentally friendly than welding, soldering, and/or brazing, when joining especially for larger cooling plate components. However, coolant containing water/ethylene glycol, is often circulated through the fluid conduit and over time it may degrade the adhesive potentially resulting in failure of the cooling plate assembly. The present disclosure overcomes such problems by providing a cooling plate assembly that is formed by bonding component plates together with an adhesive that is resistant to damage cause by the coolant. More specifically, this is achieved by incorporating epoxy-functional hydrolyzable organosilane in the adhesive. Without wishing to be bound by theory, the present inventors believe that hydrolysis and condensation of the silane groups to form new crosslinks compensate for any adhesive strength drop due to coolant attack on the adhesive.

Accordingly, in a first embodiment, the present disclosure provides a cooling plate assembly comprising at least two component plates bonded together by an adhesive, wherein the adhesive and the at least two component plates collectively define at least one fluid conduit having an inlet and an outlet, and wherein the adhesive comprises an epoxy-functional hydrolyzable organosilane compound.

In a second aspect, the present disclosure provides a method of making a cooling plate assembly, the method comprising:
disposing a curable composition between at least two component plates, and
at least partially curing the curable composition to provide an adhesive, wherein the adhesive and the at least two component plates collectively define at least one fluid conduit having an inlet and an outlet, and wherein the adhesive comprises an epoxy-functional hydrolyzable organosilane compound.

In yet another aspect, the present disclosure provides a curable composition comprising:
15 to 40 weight percent of dicyclopentadiene-based epoxy resin;
15 to 55 weight percent of at least one aromatic glycidyl ether having a functional of 1.5 to 4;
5 to 20 weight percent of core shell rubber particles;
2 to 10 weight percent of phenoxy resin;
0.1 to 20 weight percent of epoxy-functional bisphenol A novolac resin having an epoxy functionality of greater than 4;
1 to 8 weight percent of hydroxyl-functionalized polyethersulfone;
1 to 5 weight percent of surface-modified fumed silica;
0.5 to 15 weight percent of at least one epoxy-functional hydrolyzable organosilane; and
0.1 to 20 weight percent of nitrogen-based epoxy curative.

In some embodiments, the curable composition is formed into a gasket.

In this application, compounds that are not expressly identified as including one or more epoxy groups are free of epoxy groups.

Features and advantages of the present disclosure will be further understood upon consideration of the detailed description as well as the appended claims.

### BRIEF DESCRIPTION OF THE DRAWINGS

FIG. 1 is an exploded perspective view of exemplary cooling plate assembly 100 according to the present disclosure.

It should be understood that numerous other modifications and embodiments can be devised by those skilled in the art, which fall within the scope and spirit of the principles of the disclosure. The figures may not be drawn to scale.

### DETAILED DESCRIPTION

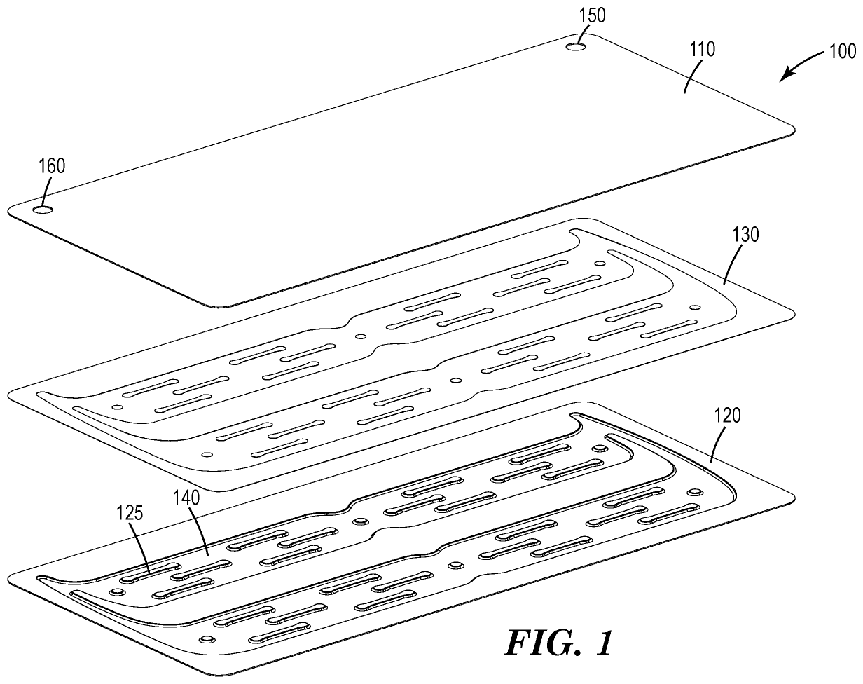

Referring now to FIG. 1, exemplary cooling plate assembly 100 comprises two component plates 110, 120 bonded together by adhesive 130. Component plate 110 is a flat on both sides with two holes, inlet 150 and outlet 160. Component plate 120 has features 125 that are raised in comparison to adjacent areas of component plate 120. Adhesive 130 contacts the raised features 125 and the first plate 110 and binds them together to collectively define fluid conduit 140. Adhesive 130 comprises an epoxy-functional hydrolyzable organosilane compound.

The adhesive may be thermoplastic (e.g., a hot melt adhesive) or a thermoset (e.g., an at least partially cured curable (i.e., thermosetting) composition).

Exemplary thermoplastic adhesives may include polyamides, polyolefins (e.g., polystyrene, polyethylene, polypropylene, styrene-co-butadiene-co-styrene copolymers, polybutene, polyisoprene, and mixtures thereof).

Exemplary curable compositions that can be at least partially cured to form useful thermosets include, epoxy resins, phenolic resins, acrylic resins (e.g., free-radically polymerizable acrylates, methacrylates, acrylamides, and/or methacrylamides), alkyd resins, methylol urea resins, aminoplasts, cyanate resins, one-part and two-part urethane resins, and combinations thereof. Often epoxy resins are used.

In some embodiments, a curable composition comprises a dicyclopentadiene-based epoxy resin, a hydrophobic epoxy resin that imparts good coolant resistance. In some embodiments, the amount of dicyclopentadiene-based epoxy resin is 15 to 40 weight percent (e.g., 15 to 30 weight percent or 18 to 25 weight percent) based on the total weight of the curable resin.

The preparation of epoxidized cycloaliphatic dicyclopentadiene phenolic resin (a dicyclopentadiene-based epoxy resin) is well known in the art. Examples of such resins and their precursors suitable for use in curable compositions of some embodiments of the present disclosure are also described, for example, in U.S. Pat. No. 3,536,734 (Vegter et al.).

In some embodiments, the dicyclopentadiene-based epoxy resin is represented by the formula

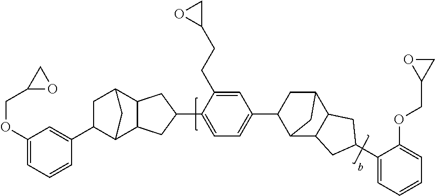

wherein b is a positive integer. One such material is available as TACTIX 756 from Huntsman Advanced Chemicals, The Woodlands, Texas. Additional materials are described in U.S. Pat. No. 4,663,400 (Wang et al.) and U.S. Pat. No. 8,173,745 (Shirrell).

In some embodiments, curable compositions include an amount of 15 to 55 weight percent (e.g., 20 to 50 weight percent or 25 to 45 weight percent) of at least one aromatic glycidyl ether having a functional of 1.5 to 4, based on the total weight of the curable composition. Preferably, the aromatic glycidyl ether is liquid at 20° C. to facilitate a composition that is tacky at 20° C. Exemplary suitable aromatic glycidyl ethers may include bisphenol A diglycidyl ethers and bisphenol F diglycidyl ethers. As used herein, the term of “bisphenol A diglycidyl ether”, as the term is commonly used in the art, refers to compounds represented by the formula

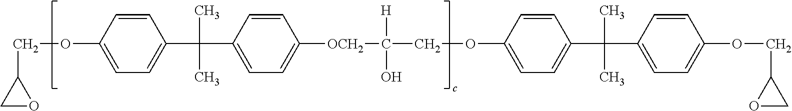

wherein c is an integer greater than equal to 0.

Likewise, as used herein, the term of “bisphenol F diglycidyl ether”, as the term is commonly used in the art, refers to compounds represented by the formula

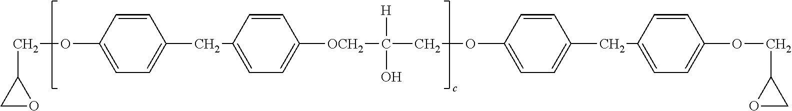

wherein c is an integer greater than or equal to 0.

Mixtures with different values of c are typical. Such materials are widely available from Dow Chemical, Midland, Michigan under the trade designation D.E.R (e.g., DER 332) and from Kaneka Texas Corporation, Pasadena, Texas (e.g., KANE ACE MX-257 which is a mixture of bisphenol A diglycidyl ether and a butadiene-acrylic copolymer core shell rubber particles).

Exemplary aromatic glycidyl ether having a functionality of 1.5 to 4 also include flexible difunctional aromatic glycidyl ether epoxy resins, for example, as available under the trade designation Cardolite (e.g., Cardolite NC-514) from Cardolite Corporation, Bristol, Pennsylvania.

In some embodiments, curable compositions include 5 to 20 weight percent or 7 to 19 weight percent of core shell rubber (CSR) particles based on the total weight of the curable composition. CSR particles may have a core selected from the group consisting of methyl methacrylate-butadiene-styrene (MBS) copolymers, methyl methacrylate-acrylonitrile-butadiene-styrene (MABS) copolymers or a combination thereof. CSR particles may also have a shell formed from an acrylic polymer, an acrylic copolymer, or a combination thereof, for example, as described in U. S., Pat. Appl. Publ. No. 2016/0297960 A1 (Aguirre-Vargas et al.). They are commercially available from suppliers such as, for example, Kaneka Texas Corporation and Kukdo Chemical, Seoul, South Korea.

In some embodiments, curable compositions include 1 to 8 weight percent (e.g., 2 to 5 weight percent) of hydroxyl-functionalized polyethersulfone. Hydroxyl-functionalized polyethersulfones are commercially available, for example, from Solvay, Brussels, Belgium under the trade designation VIRANTAGE (e.g., in grades VW-10700, VW-10200, VW-10300, and VW-10700). However, adding polyethersulfones typically decreases the flexibility of the cured adhesive and may decrease the peel adhesion to bonded substrates.

In some embodiments, curable compositions include 2 to 10 weight percent (e.g., 2 to 6 weight percent or 3 to 5 weight percent), based on the total weight of the curable composition, of phenoxy resin.

As used herein, phenoxy resins have the structural segment

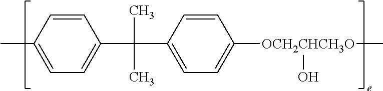

wherein e is an integer greater than 1. Often e is greater than 50, greater than 100, or even greater than 150. Phenoxy resins are available from commercial sources such as Huntsman Advanced Chemicals, The Woodlands, Texas (e.g., under the trade designation PKHH). The addition of phenoxy resin typically improves the peel adhesion of the cured adhesive, although the coolant resistance is typically not as good as seen using polyethersulfone.

In some embodiments, curable compositions include 0.1 to 20 weight percent (e.g., 1 to 15 weight percent or 3 to 8 weight percent), based on the total weight of the curable composition, of epoxy-functional bisphenol A novolac resin. Often, the epoxy-functional bisphenol A novolac resin has an average epoxy functionality of 2 to 10 or 2.5 to 10). Mixtures of epoxy-functional bisphenol A novolac resins may be used. Epoxy-functional bisphenol A novolac resins are commercially available, for example, as EPON SU-2.5 and EPON SU-8 from Hexion Specialty Chemicals, Columbus, Ohio.

In practice of the present disclosure, at least one epoxy resin may be chosen to be free of ester, and/or urethane groups, or other hydrolyzable chemical bonds which can be hydrolyzed by water or alcoholyzed by alcohol and which may then lead to degradation of adhesive properties.

In some embodiments, curable compositions include 1 to 5 weight percent (e.g., 1 to 3 weight percent), based on the total weight of the curable composition, of surface-modified fumed silica. The surface modification is typically a hydrophobic surface treatment, but other surface treatments are also permissible. Fumed silicas are available commercially for suppliers such as, for example, Evonik Corp., Essen, Germany under the trade designation AEROSIL (e.g., in grades R816, R504, R104, R106, and R709).

In some embodiments, curable compositions include 0.1 to 20 weight percent (e.g., 3 to 15 weight percent), or 4 to 15 weight percent of a nitrogen-based epoxy curative to facilitate epoxy curing. Many nitrogen-based latent epoxy resin curatives are known and include: 3,3-daminodiphenylsulfone, 4,4-daminodiphenylsulfone, dicyandiamide; acyl hydrazides such as, for example, isophthalic acid dihydrazide; substituted imidazole curatives such as those available under the trade designation CURAZOL (e.g., 2MA-OK, 2MZ-Azine) from Evonik, Essen, Germany. In some embodiments, curable compositions include 0.01 to 6 weight percent (e.g., 0.01 to 2 weight percent), based on the total weight of the curable composition, of an accelerator for dicyandiamide to facilitate epoxy curing, although it may be omitted entirely. Examples include C2MAOK and C2MZ-Azine accelerators available from Air Products and Chemicals, Allentown, Pennsylvania, and aromatic substituted ureas available under the trade designation OMICURE from Huntsman Advanced Chemicals (e.g., in grades U-52M, U-24M, and U-405).

In some embodiments, curable compositions include 0.5 to 15 weight percent (e.g., 0.5 to 3 weight percent) of epoxy-functional hydrolyzable organosilane based on the total weight of the curable composition and/or adhesive, although other amounts may be used.

Useful epoxy-functional hydrolyzable organosilanes contain at least one hydrolyzable silyl group and at least one epoxy group. Examples of hydrolyzable silyl groups (e.g., —SiX₃) include those having a silicon atom bonded to at least one group selected from alkoxy (e.g., methoxy or ethoxy), acyloxy (e.g., acetoxy), halogen (e.g., Cl, Br), and combinations thereof. Often the hydrolyzable group is a trimethoxysilyl group or a triethoxysilyl group.

Exemplary epoxy-functional hydrolyzable organosilane compounds include those represented by the formula

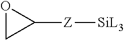

and wherein Z is a divalent organic group, and each L is independently a hydrolyzable group. Often Z contains one or more catenary oxygen atoms. In some embodiments, Z represents a hydrocarbyl group; for example, a hydrocarbyl group having from 2 to 36 carbon atoms, preferably 2 to 12 carbon atoms, and more preferably 24 carbon atoms. In some embodiments, Z represents a divalent group having the formula —CH₂OR¹— wherein R¹ represents a divalent organic group; for example, a divalent hydrocarbylene group having 2 to 12 carbon atoms, preferably 24 carbon atoms.

In some embodiments, the epoxy-functional hydrolyzable organosilane is represented by the formula

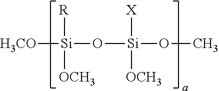

wherein R and X are each independently epoxy-based moieties and a is an integer greater than or equal to 1. One exemplary such material is available commercially as DYNASYLAN VPS 4721 from Evonik Industries AG, Essen, Germany. In some embodiments, 1 to 10 weight percent of such compounds are included in the adhesive.

Examples of suitable epoxy-functional hydrolyzable organosilane compounds also include 3-glycidoxypropyltrimethoxysilane, 3-glycidoxypropyltriethoxysilane, 2-(3,4-epoxycyclohexyl)-ethyltriethoxysilane; 2-(3,4-epoxycyclohexyl)ethylrimethoxysilane; 5,6-epoxyhexyltriethoxysilane; 8-glycidoxyoctyltrimethoxysilane; (3-glycidoxypropyl)methyldiethoxysilane; (3-glycidoxypropyl)-methyldimethoxysilane; 2-(3,4-epoxycyclohexyl)ethylmethyldiethoxysilane; (3-glycidoxypropyl)-dimethylethoxysilane; and 1-(3-glycidoxypropyl)-1,1,3,3,3-pentaethoxy-1,3-disilapropane. In some embodiments, 1 to 10 weight percent of such compounds are included in the adhesive.

Combinations of epoxy-functional hydrolyzable organosilane compounds may be, and often are used.

Additional components and additives may also be included in curable composition according to the present disclosure such as, for example, colorants, antioxidants, thixotropes, and heat-conductive and/or electrically conductive filler.

Curable compositions according to the present disclosure is supplied as a film (either free-standing or support on one or more liner(s). In some embodiments, the curable composition comprises a unitary or multipart curable gasket. For example, a film of the curable composition may have gasket portions cut out by a die punch or laser that can be separated from weed portions during assembly of a cooling plate assembly according to the present disclosure.

For example, an exemplary method of making a cooling plate assembly comprises adhering a film of a curable composition having cutout portion corresponding to raised features of a first (e.g., bottom) component plate (e.g., see raised features 125 in FIG. 1). Then, portions of the film not desired are removed by a weeding process. Then, a second component plate (e.g., a top plate which may or may not have raised features) and having inlet and outlet openings therethrough is adhered to the film and the entire assembly is heated under pressure to provide a cooling plate assembly according to the present disclosure, whereby the curable composition is sufficiently cured to form the adhesive. Through this process the adhesive and the component plates collectively define at least one fluid conduit having an inlet and an outlet, and wherein the adhesive comprises an epoxy-functional hydrolyzable organosilane compound.

Cooling plate assemblies according to the present disclosure are useful, for example, for cooling batteries by placing them adjacent to (e.g., between) battery cells often found in hybrid or full electric vehicles.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Table 1 (below) reports abbreviations and descriptions of material used in the examples.

In this application ASTM refers to ASTM International, Conshohocken, Pennsylvania,

TABLE 1

| ABBREVIATION | DESCRIPTION |
|---|---|
| AC-130-2 | Sol-gel based primer, as 3M SURFACE PRE-TREATMENT AC-130-2 |
| | from 3M Company, Maplewood, Minnesota |
| C2MAOK | An imidazole accelerator for dicyandiamide, anhydride and phenolic curing |
| | agents, available as CUREZOL 2MA-OK from Evonik Industries AG, |
| | Essen, Germany |
| C2MZ-Azine | An imidazole accelerator for dicyandiamide, anhydride and phenolic curing |
| | agents, available as CUREZOL 2MZ-Azine from Evonik Industries AG, |
| | Essen, Germany |
| DER 332 | A bisphenol A diglycidyl ether having an epoxy equivalent weight of 172- |
| | 176 grams/equivalent, available as DER 332 from Dow Chemical Co., |
| | Midland, Michigan |
| DICY | A micronized dicyandiamide, having an approximate amine equivalent |
| | weight of 21 grams/equivalent, available as ANCAMINE CG-1400 from |
| | Air Products and Chemicals |
| MX-257 | A diglycidyl ether of bisphenol-A epoxy resin containing 37.5 wt. % |
| | butadiene-acrylic copolymer core shell rubber particles and having an |
| | approximate epoxy equivalent weight of 294 grams/equivalent, available as |
| | KANE ACE MX-257 from Kaneka Texas Corporation, Pasadena, Texas |
| MX-154 | A diglycidyl ether of bisphenol-A epoxy resin containing 40 wt. % |
| | butadiene-acrylic copolymer core shell rubber particles and having an |
| | epoxy equivalent weight of 296 grams/equivalent, available as KANE ACE |
| | MX-154 from Kaneka Texas Corporation, Pasadena, Texas |
| PKHH | PKHH phenoxy resin, 52000 molecular weight, OH equivalent weight 280 |
| | grams/equivalent, from Huntsman Advanced Chemicals, The Woodlands, |
| | Texas |
| SU-2.5 | An epoxy bisphenol A novolac resin with an average epoxy functionality of |
| | 2.5, available as EPON SU-2.5 from Hexion Specialty Chemicals, |
| | Columbus, Ohio |
| SU-8 | An epoxy bisphenol A novolac resin having an average epoxy functionality |
| | of about 8, available as EPON SU-8 from Hexion Specialty Chemicals |
| EPON 1004 | A solid bisphenol A-type epoxy resin, available as EPON 1004 from |
| | Hexion Specialty Chemicals. |
| MY 721 | Multifunctional tetraglycidyl methylenedianiline (TGMDA), obtained as |
| | Araldite MY-721 from Huntsman Advanced Chemicals |
| RA 95 | A high viscosity, bisphenol A epoxy resin-modified butadiene-acrylonitrile |
| | elastomer, contains at least one ester group” obtained as HyPox RA95 from |
| | Huntsman Advanced Chemicals |
| NC 514 | A flexible difunctional aromatic glycidy1 ether epoxy resin obtained as |
| | Cardolite NC-514 from Cardolite Corporation, Bristol, Pennsylvania |
| R816 | A treated fumed silica, available as AEROSIL R816 from Evonik Corp., |
| | Essen, Germany |
| T756 | A dicyclopentadiene-based epoxy resin, available as TACTIX 756 from |
| | Huntsman Advanced Chemicals |
| U52M | An aromatic substituted urea, available as OMICURE U-52M from |
| | Huntsman Advanced Chemicals |
| IPDH | Isophthalic acid dihydrazide |
| VPS 4721 | A high molecular weight epoxy-functional hydrolyzable organosilane, |
| | available as DYNASYLAN VPS 4721 from Evonik Industries AG, Essen, |
| | Germany |
| VW-10700 | Hydroxyl-functionalized polyethersulfones (r-PESU), available as |
| | VIRANTAGE VW-10700 from Solvay, Brussels, Belgium |
| Z-6040 | γ-glycidoxypropyltrimethoxysilane, available as DOWSIL Z-6040 from |
| | Dow Chemical Co. |

### Test Methods

Grade 2024T3 bare aluminum panels were obtained from Erickson Metals of Minnesota, Inc., Coon Rapids, Minnesota. Prior to bonding with the samples, the panels were subjected to one of the following surface preparation processes:

### Panel Preparation

### Scotch-Brite Abrasive Handpad Abrasion/Sol-Gel Primed Panels

The bare aluminum panels were slightly abraded with a green 3M SCOTCH-BRITE abrasive handpad (obtained from 3M Company) to remove the surface oxide layer for about 10-30 seconds. Residual dust was removed by means of compressed air, rinsing with solvent and allowing to dry for 10 minutes at approximately 25° C. The aluminum panel was then pre-treated using 3M Surface Pre-Treatment AC-130-2, 3M, Maplewood, Minnesota.

AC-130-2 and dried at 75° F. (23.9° C.) for 60 minutes according to the manufacturers directions, after which curable composition was applied, and heated at 350° F. (177° C.) for 30 minutes.

### Overlap Shear Strength (OLS) Test

A curable composition was applied onto the end of the primed aluminum panel (measuring 4 inches×1 inch×0.063 inch (10.16 cm×2.54 cm×0.16 cm)) and a second equally sized primed aluminum panel was then applied over the sample at an overlap of 0.5 inches (12.7 mm). The assembly was clamped together using metal clamps and cured as described above.

Overlap shear strength was measured according to ASTM D1002-10 (2019) “Standard Test Method for Apparent Shear Strength of Single-Lap-Joint Adhesively Bonded Metal Specimens by Tension Loading (Metal-to-Metal)”, using a model SINTECH-30 tensile tester, obtained from MTS Corporation, Eden Prairie, Minnesota, at a grip separation rate of 0.05 inches/minute (1.3 mm/min). Three test panels were prepared and evaluated per each example.

### Floating Roller Peel (FRP) Strength Test

Two primed and etched aluminum panels, one measuring 63 mils by 8-inches by 1-inches (1.60 mm by 20.32 cm by 2.54 cm), the other measuring 25 mils by 10-inches by 3-inches (0.635 mm by 25.4 cm by 2.54 cm), were bonded together as described in the Overlap Shear Strength Test. Test strips, from the bonded panel assembly were evaluated for floating roller peel strength of the thinner substrate, according to ASTM D3167-10 (2017) “Standard Test Method for Floating Roller Peel Resistance of Adhesives” using a tensile strength tester, model SINTECH 20 from MTS Corporation, at a separation rate of 6 inches/minute (15.24 cm/min) and at 70° F. (21.1° C.). Three test panels were prepared and evaluated per each example.

### Coolant Immersion Aging Test

A set of the testing OLS specimens are made according to OLS standard procedure stated above.

After they are made, they were placed into PRESTONE DEX-COOL coolant (50/50 ethylene glycol-water, from Prestone Products Corp. of Lake Forest, Illinois) at 90° C. for aging. After two, four, six, nine, and/or twelve weeks, the sample was removed and OLS testing was performed.

### Glass Transition Temperature Test

Glass transition temperature (T_{g}) was determined by DMA and according to ASTM E1640-13 (2018). Samples approximately 1-2 mm thick, 6-10 mm wide and 20 mm long were machined from a larger sample of cured epoxy. Sample thickness and width were measured at three points along the specimen length using a micrometer, and the average of these measurements was used for calculation of cross-sectional area. Length of samples were measured by TA Instruments Q800 DMA. DMA testing was performed using a TA Instruments Q800 DMA. The T_{g} was used by the onset T_{g} of the storage modulus, according to ASTM D7028-07 (2015).

### Examples Ex1-Ex8 and Comparative Examples Ce1-Ce5

### Step 1

DER 332, SU-2.5, SU-8, MX 257, MX 154, MY 721, RA 95, EPON 1004 and DER 332 were combined in quantities (listed in grams), indicated in Table 2, and melted together at 300° F. (149° C.). After the mixture melted, the VW-10700, or PKHH, or its blend was added, and agitation continued at 300° F. (149° C.) until the polymers dissolved. After it was dissolved, T756 was added and agitated until it was melted.

### Step 2

The mixtures from Step 1 were cooled to 220° F. (104° C.) and Z-6040 and/or VPS 4721 (if needed) was added. The fumed silica was added and dispersed using a high-speed mixer along with curatives as reported in Table 2. Mixing time was limited to no more than two minutes and care was taken to ensure that the mixture did not over-heat during mixing.

### Step 3

The mixture from Step 2 was immediately used to draw a film on a silicone-coated liner. A film adhesive was achieved for each of the Examples and Comparative Examples listed in Table 2.

### Step 4

The samples underwent OLS, FRP, Coolant Immersion, and Glass Temperature Testing and the results are reported in Table 3.

TABLE 2

| | PARTS BY WEIGHT | | | | | | | | | | | | |
|---|---|---|---|---|---|---|---|---|---|---|---|---|---|
| COMPONENT | CE1 | CE2 | CE3 | CE4 | CE5 | EX1 | EX2 | EX3 | EX4 | EX5 | EX6 | EX7 | EX8 |
| T756 | 20.0 | 20.0 | 20.0 | 15 | 20 | 20.0 | 20.0 | 20.0 | 20.0 | 20.0 | 20.0 | 23.2 | 23.1 |
| MX-257 | 30.0 | 30.0 | 30.0 | 0 | 30 | 30.0 | 30.0 | 30.0 | 30.0 | 30.0 | 30.0 | 34.7 | 34.6 |
| MX 154 | 0 | 0 | 0 | 30 | 0 | 0 | 0 | 0 | 0 | 0 | 0 | 0 | 0 |
| NC -514 | 0 | 0 | 0 | 0 | 0 | 0 | 0 | 0 | 0 | 0 | 0 | 0 | 5.8 |
| MY 721 | 0 | 0 | 0 | 5 | 10 | 0 | 0 | 0 | 0 | 0 | 0 | 0 | 0 |
| RA 95 | 0 | 0 | 0 | 10 | 0 | 0 | 0 | 0 | 0 | 0 | 0 | 0 | 0 |
| EPON 1004 | 0 | 0 | 0 | 0 | 10 | 0 | 0 | 0 | 0 | 0 | 0 | 0 | 0 |
| PKHH | 0 | 0 | 3.0 | 0 | 0 | 5.0 | 3.5 | 3.5 | 5.0 | 3.5 | 5.0 | 5.8 | 5.8 |
| DER 332 | 2.0 | 2.0 | 2.0 | 0 | 2 | 2.0 | 2.0 | 2.0 | 2.0 | 2.0 | 2.0 | 16.8 | 2.3 |
| SU 2.5 | 5.0 | 5.0 | 5.0 | 0 | 0 | 5.0 | 5.0 | 5.0 | 5.0 | 5.0 | 5.0 | 0 | 0 |
| SU 8 | 5.0 | 5.0 | 5.0 | 5 | 25 | 5.0 | 5.0 | 5.0 | 5.0 | 5.0 | 5.0 | 5.8 | 5.8 |
| VW-10700 | 3.0 | 3.0 | 0 | 4 | 3 | 3.0 | 3.0 | 3.0 | 3.0 | 3.0 | 3.0 | 3.5 | 3.5 |
| R816 | 2.0 | 2.0 | 2.0 | 2 | 2 | 2.0 | 2.0 | 2.0 | 2.0 | 2.0 | 2.0 | 1.5 | 2.3 |
| DICY | 5.0 | 5.0 | 4.5 | 4.5 | 7 | 5.0 | 5.0 | 5.0 | 5.0 | 5.0 | 5.0 | 6.5 | 0 |
| IPDH | 0 | 0 | 0 | 0 | 0 | 0 | 0 | 0 | 0 | 0 | 0 | 0 | 13.8 |
| Z-6040 | 1.0 | 1.0 | 1.0 | 0 | 0 | 1.0 | 1.0 | 0 | 0 | 0 | 0 | 0 | 0 |
| VPS 4721 | 0 | 0 | 0 | 0 | 0 | 0 | 0 | 1.0 | 1.0 | 1.1 | 1.1 | 1.2 | 1.2 |
| U52M | 0 | 0 | 0 | 2 | 0 | 0 | 0 | 0 | 0 | 0.2 | 0.2 | 0.3 | 1.2 |
| C2MAOK | 0.55 | 0.55 | 0.55 | 0 | 0.55 | 0.55 | 0.55 | 0.55 | 0.55 | 0 | 0 | 0 | 0 |
| C2MZ-Azine | 0 | 0 | 0 | 0 | 0 | 0 | 0 | 0 | 0 | 0.55 | 0.55 | 0.8 | 0.8 |

TABLE 3

| | CE1 | CE2 | CE3 | CE4 | CE5 | EX1 | EX2 | EX3 | EX4 | EX5 | EX6 | EX7 | EX8 |
|---|---|---|---|---|---|---|---|---|---|---|---|---|---|
| T_{g}, Dry (° C.) | | 162 | 158 | 157 | | | | 165 | 157 | | 154 | 166 | 166 |
| T_{g}, Wet (° C.) | | 87 | 81 | 78.2 | | | | 93 | 90 | | 86.5 | 86.6 | 138 |
| FRP (N/mm) | <0.5 | <1 | 4.51 | 2.8 | | 5.39 | 4.71 | 3.92 | 4.5 | 5.05 | 5.75 | 3.9 | 2.7 |
| Control, OLS (MPa) | 25.1 | 26.8 | 25.4 | 26.9 | 23.4 | 23.2 | 22.5 | 25.3 | 25 | 26.2 | 29.4 | 25.4 | 23.9 |
| 2 weeks in coolant (MPa) | 14.2 | 25.3 | | 18.6 | 9.5 | 23.2 | 19.8 | 17.8 | 23 | 15.4 | 22.2 | 22.8 | 19.7 |
| 4 weeks in coolant (MPa) | | 32.6 | 18.2 | | | 23.6 | 24.2 | 20.9 | 26.4 | 23.2 | 26.5 | | 24.7 |
| 6 weeks in coolant (MPa) | | 32 | 15.8 | | 8.9 | 22 | 22.6 | 23.6 | 26.2 | 24.1 | 27.5 | 22.8 | 21.5 |
| 9 weeks in coolant (MPa) | | | | 15.7 | | 21.1 | 19 | 22.4 | 24.3 | 24.3 | 26.6 | 25.8 | |
| 12 weeks in coolant (MPa) | 13.7 | 27.5 | 16.9 | 14.6 | | 19.3 | 18.9 | 17.8 | 20.9 | 25.2 | 22.9 | 26.2 | 19.2 |

All cited references, patents, and patent applications in this application are incorporated by reference in a consistent manner. In the event of inconsistencies or contradictions between portions of the incorporated references and this application, the information in this application shall control.

The preceding description, given in order to enable one of ordinary skill in the art to practice the claimed disclosure, is not to be construed as limiting the scope of the disclosure, which is defined by the claims and all equivalents thereto.

1. A cooling plate assembly comprising at least two component plates bonded together by an adhesive, wherein the adhesive and the at least two component plates collectively define at least one fluid conduit having an inlet and an outlet, and wherein the adhesive comprises an epoxy-functional hydrolyzable organosilane compound.

2. The cooling plate assembly of claim 1, wherein the adhesive comprises an at least partially cured curable composition.

3. The cooling plate assembly of claim 1, wherein the epoxy-functional hydrolyzable organosilane compound is represented by the formula 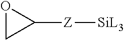
and wherein Z is a divalent organic group having from 1 to 12 carbon atoms and each L is independently a hydrolyzable group.

4. The cooling plate assembly of claim 1, wherein the epoxy-functional hydrolyzable organosilane compound comprises γ-glycidoxypropyltrimethoxysilane.

5. The cooling plate assembly of claim 2, wherein the curable composition comprises an epoxy resin.

6. The cooling plate assembly of claim 2, wherein the curable composition comprises:
15 to 40 weight percent of dicyclopentadiene-based epoxy resin;
15 to 55 weight percent of at least one aromatic glycidyl ether having a functional of 1.5 to 4;
5 to 20 weight percent of core shell rubber particles;
2 to 10 weight percent of phenoxy resin;
0.1 to 20 weight percent of epoxy-functional bisphenol A novolac resin having an epoxy functionality of greater than 4;
1 to 8 weight percent of hydroxyl-functionalized polyethersulfone;
1 to 5 weight percent of surface-modified fumed silica;
0.5 to 15 weight percent of at least one epoxy-functional hydrolyzable organosilane; and
0.1 to 20 weight percent of nitrogen-based epoxy curative.

7. The cooling plate assembly of claim 6, wherein the curable composition comprises:
15 to 30 weight percent of dicyclopentadiene-based epoxy resin;
25 to 45 weight percent of at least one aromatic glycidyl ether having a functional of 1.5 to 4;
7 to 19 weight percent of core shell rubber particles;
2 to 6 weight percent of phenoxy resin;
4 to 10 weight percent of epoxy-functional bisphenol A novolac resin having an epoxy functionality of greater than 4;
2 to 5 weight percent of hydroxyl-functionalized polyethersulfone;
1 to 3 weight percent of surface-modified fumed silica;
0.5 to 3 weight percent of epoxy-functional hydrolyzable organosilane; and
0.1 to 8 weight percent of nitrogen-based epoxy curative.

8. A method of making a cooling plate assembly, the method comprising:
disposing a curable composition between at least two component plates, and
at least partially curing the curable composition to provide an adhesive, wherein the adhesive and the at least two component plates collectively define at least one fluid conduit having an inlet and an outlet, and wherein the adhesive comprises an epoxy-functional hydrolyzable organosilane compound.

9. The method of claim 8, wherein the curable composition comprises a solid at 20° C.

10. The method of claim 8, wherein the curable composition comprises a curable gasket.

11. The method of claim 8, wherein the epoxy-functional hydrolyzable organosilane compound is represented by the formula 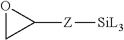
and wherein Z is a divalent organic group having from 1 to 12 carbon atoms and each L is independently a hydrolyzable group.

12. The method of claim 8, wherein the epoxy-functional hydrolyzable organosilane compound comprises γ-glycidoxypropyltrimethoxysilane.

13. The method of claim 8, wherein the curable composition comprises an epoxy resin.

14. The method of claim 8, wherein the curable composition comprises:
15 to 40 weight percent of dicyclopentadiene-based epoxy resin;
15 to 55 weight percent of at least one aromatic glycidyl ether having a functional of 1.5 to 4;
5 to 20 weight percent of core shell rubber particles;
2 to 10 weight percent of phenoxy resin;
0.1 to 20 weight percent of epoxy-functional bisphenol A novolac resin having an epoxy functionality of greater than 4; 1 to 8 weight percent of hydroxyl-functionalized polyethersulfone;
1 to 5 weight percent of surface-modified fumed silica;
0.5 to 15 weight percent of at least one epoxy-functional hydrolyzable organosilane; and
0.1 to 20 weight percent of nitrogen-based epoxy curative.

15. The method of claim 8, wherein the curable composition comprises:
15 to 30 weight percent of dicyclopentadiene-based epoxy resin;
25 to 45 weight percent of at least one aromatic glycidyl ether having a functional of 1.5 to 4;
7 to 19 weight percent of core shell rubber particles;
2 to 6 weight percent of phenoxy resin;
4 to 10 weight percent of epoxy-functional bisphenol A novolac resin having an epoxy functionality of greater than 4;
2 to 5 weight percent of hydroxyl-functionalized polyethersulfone;
1 to 3 weight percent of surface-modified fumed silica;
0.5 to 3 weight percent of epoxy-functional hydrolyzable organosilane; and
0.1 to 8 weight percent of nitrogen-based epoxy curative.

16. A curable composition comprising:
15 to 40 weight percent of dicyclopentadiene-based epoxy resin;
15 to 55 weight percent of at least one aromatic glycidyl ether having a functional of 1.5 to 4;
5 to 20 weight percent of core shell rubber particles;
2 to 10 weight percent of phenoxy resin;
0.1 to 20 weight percent of epoxy-functional bisphenol A novolac resin having an epoxy functionality of greater than 4;
1 to 8 weight percent of hydroxyl-functionalized polyethersulfone;
1 to 5 weight percent of surface-modified fumed silica;
0.5 to 15 weight percent of at least one epoxy-functional hydrolyzable organosilane; and
0.1 to 20 weight percent of nitrogen-based epoxy curative.

17. The curable composition of claim 16, wherein the curable composition comprises:
15 to 30 weight percent of dicyclopentadiene-based epoxy resin;
25 to 45 weight percent of at least one aromatic glycidyl ether having a functional of 1.5 to 4;
7 to 19 weight percent of core shell rubber particles;
2 to 6 weight percent of phenoxy resin;
4 to 10 weight percent of epoxy-functional bisphenol A novolac resin having an epoxy functionality of greater than 4;
2 to 5 weight percent of hydroxyl-functionalized polyethersulfone;
1 to 3 weight percent of surface-modified fumed silica;
0.5 to 3 weight percent of epoxy-functional hydrolyzable organosilane; and
0.1 to 8 weight percent of nitrogen-based epoxy curative.

18. The curable composition of claim 16, wherein the curable composition is solid at 20° C.

19. The curable composition of claim 18, wherein the curable composition is tacky at 20° C.

20. The curable composition of claim 16, wherein the curable composition is formed into a gasket.
